(19) United States
(12) Patent Application Publication
(10) Pub. No.: US 2005/0212483 A1
(43) Pub. Date: Sep. 29, 2005

(54) Charging/discharging management system for lithium battery packs

(76) Inventor: Wenman Li, XinXiang (CN)

Correspondence Address: KAO H. LU, 686 LAWSON AVE, HAVERTOWN, PA, 19083, US

(21) Appl. No.: 10/809,303

(22) Filed: Mar. 24, 2004

(51) Int. Cl. H02J 7/00

(52) U.S. Cl. 320/128

(57) ABSTRACT

This invention is a management protection circuit to be used with a battery pack to prevent the charging or discharging of the battery from exceeding the upper and lower voltage thresholds. The over-discharging protection adopts a high accuracy, low power consumption, four OP AMPs comparison circuit. Its static working current is less than 0.3 mA. The charging balance protection adopts a combined circuit of a high accuracy, low power consumption, four OP AMPs comparison circuit and a direct current inverter. When any of battery units in a battery pack reaches the upper voltage threshold of charging condition, the inverter goes into an active state and takes the charging electrical energy back to the charging system. Thus, the electrical energy can be fully utilized. It also reduces the temperature raised on the charging system and increases the system's reliability.

### BACKGROUND OF THE INVENTION

A lithium battery as a new type of rechargeable battery has wide applications due to its high quality and pollution-free feature. In many areas, a lithium battery has gradually replaced other types of rechargeable batteries. However, the usage conditions for a lithium battery are relatively restricted. Because an improper usage can reduce the battery's life span and damage the battery, adding a protection circuit for charging or discharging a battery to the commercial lithium batteries can prevent the improper usage from happening. For a single unit lithium battery, a charging/discharging protection circuit is installed to meet the normal usage conditions; the battery provides a steady output voltage of 3.6V; during charging, the upper voltage threshold should not exceed 4.2 V, while during discharging the lower voltage threshold should not go down below 2.75 V. And the voltage variances for upper and lower voltage thresholds should maintain within ±1%, i.e., about 50 mV. To protection of single unit lithium battery (e.g., a battery for a portable phone) to meet the aforementioned requirements is not too difficult. However, it becomes quite challenge for a charging/discharging system of a lithium battery pack that has 10 or more serially connected battery units. For example, a battery pack for electrical cars can have more than 80 units connected in series.

Currently, there are two approaches for the charging/discharging management systems of lithium batteries: (1) Cutoff approach: monitoring voltages of every single unit battery in a battery pack, the system stops charging or discharging when the voltage of any unit battery reaches its upper threshold or lower threshold. (2) Single unit charging approach: The lower voltage threshold is handled similarly as cutoff approach. The upper voltage threshold is handled by charging each battery unit with an individual power supply at a constant voltage and current until itself reaching the upper voltage threshold.

The first approach is relatively simpler, less costly and easier to implement than the second one. However, it's not very effective in the real applications. Because each battery unit has its own discharging rate and inconsistence among protection circuits and working batteries, when a battery pack has been used through a period of cycles, a voltage difference (i.e., capacity difference) is created among each individual battery unit. This cutoff approach can't compensate this problem. Eventually, the actual useable life of a battery is much shorter than the original designed. The second single unit charging approach is more effective but it costs too high. Especially, the complicated structure and interface creates some difficulties in practical application.

### SUMMARY OF THE INVENTION

This invention overcomes the drawbacks of aforementioned two approaches and provides a new low-cost circuit design for the battery pack that consumes less energy and provides a more consistent and efficient battery performance. The new circuit design has the following features.

1. Charging/discharging monitoring and protection circuit uses four OP AMPs (four voltage comparators) for every two battery units.

2. Charging balance protection uses circuits consisting of an OP AMP (voltage comparator) and a DC inverter: when any battery unit in a battery pack reaches its upper voltage threshold, the DC inverter circuit goes into action; the charging energy for that battery unit is fed back to the entire battery pack. Thus, the charging energy can be effectively utilized to increase charging efficiency and decrease temperature raised on a charging system. This improves reliability of a charging system.

3. The trigger signal for the inverter is controlled by a monitoring circuit. There is no electrical energy consumption when an inverter circuit is not in action.

4. When all the battery units are fully charged, a comparator sends a control signal to stop the charging power supply.

### BRIEF DESCRIPTION OF THE DRAWINGS

FIG. 1 illustrates how the charging/discharging management system works.

### DETAILED DESCRIPTION OF THE INVENTION

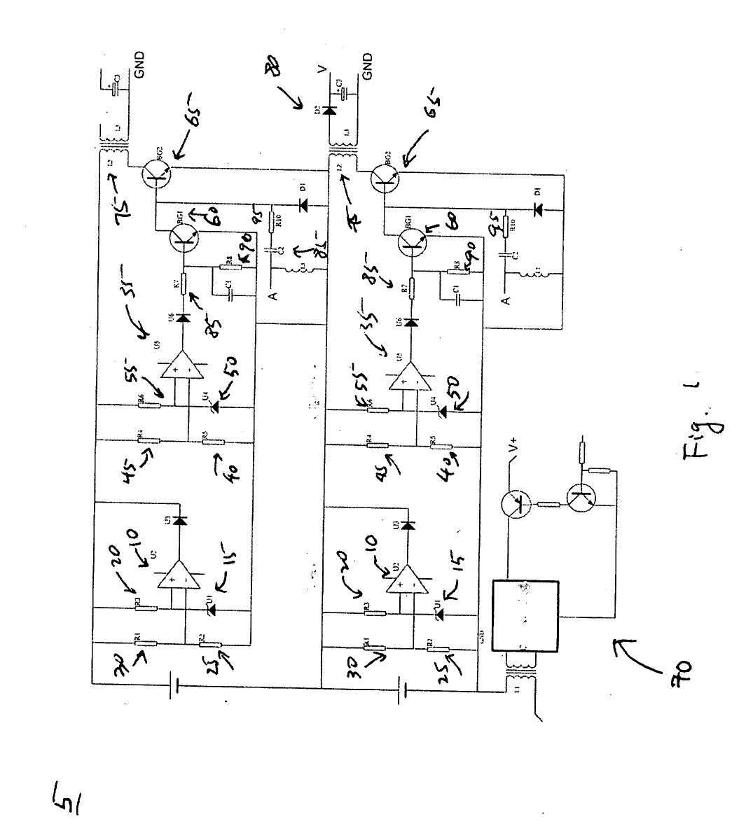

For a lithium battery under a normal working condition, its upper voltage threshold is below 4.2V and its lower voltage threshold is above 2.75 V. Based on this characteristic, a pair of two OP AMPs or two comparators can accomplish the objectives of cutting off a charging power supply when the voltage of a battery reaches the upper threshold, and cutting off a load when it reaches the lower threshold. This circuit is called the threshold circuit. In FIG. 1, U2 10 is a lower voltage threshold comparator used for discharging; U2 10 compares a reference voltage (between R3 20 and U1 15) at the positive end of input and a battery input (between R1 30 and R2 25) at the negative end. When the voltage of a battery decreases, the electrical potential at the negative end also decreases accordingly. When the electrical potential reaches or falls below the reference voltage, the comparator U2 10 raises the output voltage to a high level; this will then trigger an electronic switch or a relay to cut off the load. In case of a battery pack consisting of a large number of battery units, an optical coupling is used to convert electrical potential before being fed to a single chip controller to trigger the executing circuit (i.e. switching component). The upper voltage threshold comparator (U5 35) works in the similar way except its output states are reversed. U5 35 compares a reference voltage (between R6 55 and U4 50) at the positive end of input and a battery input (between R4 and R5 40) at the negative end. At normal condition, it maintains a high potential. BG1 60 is conducting and resistance between C (Collector) and E (Emitter) is low. BG2 65 is in cutoff state. During charging, when the voltage of a battery reaches the upper voltage threshold, the output of comparator U5 35 jumps to a low potential, BG1 60 is changed from fully conducting to cut-off state, BG2 65 is changed from cutoff to the conducting condition. At meaning time, a synchronized Trigger Signal Generator 70 sends rectangular waves to the Base of BG2 65, and through the Collector, the DC energy is converted to a high frequency electrical energy with rectangular wave shape and this energy is fed to the high frequency transformer (L2 75). Coming off a secondary coil, the electrical energy is rectified and filtered by D2 80 and C2 85, and then sent back to the battery pack. This is a dynamic process. The control process sequences are as follows: electrical potential of a battery increase, output at the comparator U5 35 decreases, internal resistance of BG1 60 increases, output electrical energy of BG2 65 increases; then voltage of the battery decreases, output of the comparator increases, output impedance of BG1 60 decreases, output electrical energy of BG2 65 decrease. Through these rapidly dynamic adjustments, the terminal voltage of the battery is always kept at the designated value. For a battery pack, each battery unit has its own pair of threshold comparators. When all upper voltage threshold comparators are no longer in high electrical level, it indicates that all battery units in a battery pack reach their upper voltage thresholds (i.e. fully charged). At this moment, the threshold circuit (or the single chip controller) issues a command to cut off the charging power supply. The charging process is completed.

In this invention, every of the four OP AMPs (or four voltage comparators) forms two upper-lower voltage threshold circuits, which can control the terminal voltages of two battery units. For every battery, the upper-lower voltage threshold protection circuit has the same design and structure.

In FIG. 1, U2 10 is part of a lower voltage threshold comparator, U5 35 is part of an upper voltage threshold comparator, R7 85 is a current limiting resistance, and R8 90 is a stabilizing resistance. Resistance R10 95 is to ensure that a trigger signal does not get short circuited when BG1 60 is saturated and conducting.

In real world applications, U2 10 and U5 35 share one common reference voltage (2.5V). BG1 60 adopts a FET to further reduce the electrical consumption of the battery during inactive state.

1. A charging/discharging management system for Lithium battery packs comprising:
means for determining by a first comparison circuit whether the voltage of a rechargeable battery reaches or falls below a designated lower level during discharging; when this occurs said comparison circuit sends a signal to a control circuit to cut off the load accordingly;
means for determining by a second comparison circuit whether the voltage of a rechargeable battery reaches a designated upper level during charging; when this occurs the said second comparison circuit sends a signal to a feedback circuit to send leftover charging energy back to the entire battery pack;
a high frequency energy conversion circuit for converting leftover charging energy into suitable form back to the entire battery pack; and
a trigger signal generator generates high frequency rectangular waves, which are sent to said high frequency energy conversion circuit for enabling energy conversion process.

2. A charging/discharging management system for Lithium battery packs comprising of claim 1, wherein said first comparison circuit is an OP AMP.

3. A charging/discharging management system for Lithium battery packs comprising of claim 1, wherein said second comparison circuit is an OP AMP.

4. A charging/discharging management system for Lithium battery packs comprising of claim 1, wherein said high frequency energy conversion circuit further comprising a first and a second FETs and a high frequency transformer; where the signal generated by said second comparison circuit is amplified by said first FET and then fed through said second FEF aided by rectangular signals from said trigger signal generator, in which the charging electrical energy is converted into high frequency electrical energy then is transformed by said transformer and rectified, filtered, and eventually sent back to the entire battery pack.

5. A charging/discharging management system for Lithium battery packs comprising of claim 1, wherein when all battery units meet the charging requirements, all upper voltage threshold comparison circuits no longer sending output at high electrical levels, which indicates the charging is completed.
